(19) United States
(12) Patent Application Publication
(10) Pub. No.: US 2016/0108833 A1
(43) Pub. Date: Apr. 21, 2016

(54) SYSTEM AND METHOD FOR CONTROLLING AIR-FUEL RATIO OF CNG ENGINE

(71) Applicant: HYUNDAI MOTOR COMPANY, Seoul (KR)

(72) Inventor: Jin Woo CHOUNG, Suwon-si (KR)

(21) Appl. No.: 14/665,965

(22) Filed: Mar. 23, 2015

(30) Foreign Application Priority Data
Oct. 20, 2014 (KR) 10-2014-0141671

(51) Int. Cl. F02D 41/00; F01N 11/00; F02B 43/10; F02D 41/14; F02B 43/12; F01N 3/10; F02D 41/02

(52) U.S. Cl. CPC F02D 41/0027; F01N 3/101; F01N 11/007; F02D 41/0235; F02D 41/1454; F02D 41/1441; F02B 43/12; F02B 43/10; F02B 2043/103; F01N 2550/02

(57) ABSTRACT

A system includes a compressed natural gas (CNG) engine, a three-way catalyst (TWC), a first oxygen sensor connected to the CNG engine, and a second oxygen sensor connected to the three-way catalyst. A method for controlling an air-fuel ratio of the CNG engine includes determining whether or not the CNG engine and the three-way catalyst are normal by measuring output voltages of the first and second oxygen sensors, determining whether or not the three-way catalyst is aged, and adjusting the air-fuel ratio of the CNG engine based on a result of the step of determining whether or not the three-way catalyst is aged

### CROSS-REFERENCE(S) TO RELATED APPLICATIONS

The present application claims the benefit of priority to Korean Patent Application Number 10-2014-0141671 filed on Oct. 20, 2014, the entire contents of which application are incorporated herein for all purposes by this reference.

### TECHNICAL FIELD

The present disclosure relates to a method for controlling an air-fuel ratio of a Compressed Natural Gas (hereinafter, CNG) engine; and, particularly, to a method for controlling an air-fuel ratio of a CNG engine, capable of improving purification efficiency for exhaust gas and a life of a three-way catalyst by controlling an air-fuel ratio of a CNG engine such that the three-way catalyst used in the CNG engine has maximum activation.

### BACKGROUND

Natural gas used in vehicles may be classified into CNG and LNG according to a fuel supply method. The CNG is gas compressed at about 200 atmospheres and is used in a state of being stored in a high-pressure container. The LNG is cryogenic gas having a temperature of about −130° C. and is supplied as vehicle fuel.

CNG refers to natural gas produced out of the ground in a broad sense, but generally refers to combustible gas containing hydrocarbon as a main ingredient.

CNG is largely classified into oil-field gas produced out of an oil field, coal-field gas produced out of a coal field, and water-soluble gas which is soluble and present in water regardless of occurrence of oil or coal. Each of the coal-field gas and the water-soluble gas contains methane as a main ingredient, carbon dioxide, oxygen, nitrogen, etc., and is referred to as dry gas since the gas is not liquefied by pressurization at the room temperature. The oil-field gas contains propane, butane, etc., in addition to the methane, and is referred to as wet gas since the gas is liquefied by pressurization at the room temperature.

In a case in which the CNG is used as fuel of the vehicles, the CNG has advantages that it is cheap and economically feasible. In addition, combustion efficiency is increased and the engine is quiet since the CNG is mixed with air in the form of gas in a mixer to be introduced into a cylinder and is perfectly combusted at a value approximate to a theoretical air-fuel ratio in a uniform state. Furthermore, knocking is not generated since the CNG has combustion speed slower than gasoline and has a high octane value.

In addition, the CNG engine is economically feasible and has a high fuel rate, an engine oil injection rate, an engine life, and the like, compared to the gasoline engine. The CNG is fully evaporated in the cylinder since having a low boiling point, and thus thin oil and carbon are not generated.

In addition, the oil is not contaminated due to carbon or ash since additives are not used, and metal corrosion is not caused by exhaust gas since a sulfur ingredient is not nearly contained in the CNG.

Accordingly, the CNG does not cause air pollution and is sanitary. In addition, since a content of CO which is a noxious substance is low, the exhaust gas is nearly destitute of smell and smoke is not nearly present.

However, the advantages of the natural gas vehicle are significantly cancelled out due to unburned methane (CH₄) emission. Methane is a latent greenhouse gas substance, and has a long life and a high effect compared to carbon dioxide.

In the CNG engine, the exhaust gas is purified by application of a three-way catalyst (TWC). In a rich condition, contaminants such as carbon dioxide, methane, and nitrogen oxide are normally removed due to fuel characteristics of CNG. However, the performance of the three-way catalyst is deteriorated in a lean region, namely, when a lambda (λ) value is equal to or more than 1.02.

FIGS. 1A to 1C are graphs illustrating a relationship between an air-fuel ratio and a purification performance according to aging of a three-way catalyst as low precious metal. FIGS. 2A to 2C are graphs illustrating a relationship between an air-fuel ratio and a purification performance according to aging of a three-way catalyst as high precious metal.

As shown in FIGS. 1A to 2C, the three-way catalyst is maximally activated at an initial air-fuel ratio, namely, when a lambda value is 1.00, but is maximally activated when the lambda value is 0.99 according to aging thereof.

Accordingly, it is necessary to develop a technique in which purification efficiency for exhaust gas may be improved by constantly maximum activation of a catalyst so as to cope with the enhanced emission restriction such as EURO 6 executed in Europe.

A conventional device in which oxygen sensors are mounted to an exhaust pipe of an engine and an end of a three-way catalyst converter, respectively, and an air-fuel ratio of the engine is controlled according to exhaust gas detected by the oxygen sensors so that purification efficiency for the exhaust gas is improved is specifically disclosed in “an air-fuel ratio control device of a vehicle engine” and the like.

However, since the conventional device does not consider performance deterioration problems at all due to aging of the catalyst, there is a problem in that the purification efficiency for the exhaust gas is deteriorated as the catalyst is aged.

### SUMMARY

An embodiment of the present invention is directed to a method for controlling an air-fuel ratio of a CNG engine, capable of improving purification efficiency for exhaust gas in a CNG engine while increasing a life of a three-way catalyst installed to the CNG engine.

Another aspect of embodiments of the present invention is directed to a method for controlling an air-fuel ratio of a CNG engine, capable of easily determining whether or not a three-way catalyst is aged and a replacement time of the three-way catalyst.

Other objects and advantages of the present invention can be understood by the following description, and become apparent with reference to embodiments of the present invention.

In accordance with an embodiment of the present invention, a method for controlling an air-fuel ratio of a CNG engine in which a first oxygen sensor is connected to the CNG engine and a second oxygen sensor is connected to a three-way catalyst is disclosed. The method may include determining whether or not the CNG engine and the three-way catalyst are normal by measuring output voltages of the first and second oxygen sensors, determining whether or not the three-way catalyst is aged, and adjusting the air-fuel ratio of the CNG engine based on a result of the step of determining whether or not the three-way catalyst is aged.

The method may include measuring the output voltage of the first oxygen sensor, determining whether or not the CNG engine is normal by comparing the output voltage of the first oxygen sensor with a first CNG reference range, measuring the output voltage of the second oxygen sensor, determining whether or not the three-way catalyst is normal by comparing the output voltage of the second oxygen sensor with a first TWC reference range, determining whether or not the three-way catalyst is aged by comparing the output voltage of the second oxygen sensor with a second TWC reference range, and adjusting the air-fuel ratio of the CNG engine according to a result of the step of determining whether or not the three-way catalyst is aged.

In certain embodiments, the first oxygen sensor may be a linear oxygen sensor and the second oxygen sensor may be a binary oxygen sensor.

In certain embodiments, in the step of determining whether or not the CNG engine is normal, the first CNG reference range may be −2 mV to 1 mV, and the CNG engine may be determined to be abnormal when the output voltage of the first oxygen sensor is less than or more than the first CNG reference range.

In the determining whether or not the three-way catalyst is normal, the first TWC reference range may be 0.75 V to 0.87 V, and the three-way catalyst may be determined to be normal when the output voltage of the second oxygen sensor is in the first TWC reference range.

In the step of determining whether or not the three-way catalyst is aged, the second TWC reference range may be 0.67 V to 0.75 V, and the three-way catalyst may be determined to be aged when the output voltage of the second oxygen sensor is in the second TWC reference range.

In the step of adjusting the air-fuel ratio, the air-fuel ratio of the CNG engine may be adjusted to be 0.99 when the three-way catalyst is determined to be aged.

In certain embodiments, the method may further include replacing the three-way catalyst when the output voltage of the second oxygen sensor is below the second TWC reference range. In certain embodiments, the method may include replacing the three-way catalyst when the output voltage of the second oxygen sensor is less than 0.67 V.

In certain embodiments, a system may include a CNG engine, a three-way catalyst, a first oxygen sensor connected to the CNG engine, a second oxygen sensor connected to the three-way catalyst, and a controller. The controller may be configured to measure an output voltage of the first oxygen sensor, determine whether or not the CNG engine is normal by comparing the output voltage of the first oxygen sensor with a first CNG reference range, measure an output voltage of the second oxygen sensor, determine whether or not the three-way catalyst is normal by comparing the output voltage of the second oxygen sensor with a first TWC reference range, determine whether or not the three-way catalyst is aged by comparing the output voltage of the second oxygen sensor with a second TWC reference range, and adjust an air-fuel ratio of the CNG engine depending on whether or not the three-way catalyst is aged.

### BRIEF DESCRIPTION OF THE DRAWINGS

FIGS. 1A to 1C are graphs illustrating a relationship between an air-fuel ratio and a purification performance according to aging of a three-way catalyst as low precious metal.

FIGS. 2A to 2C are graphs illustrating a relationship between an air-fuel ratio and a purification performance according to aging of a three-way catalyst as high precious metal.

FIG. 3 is a diagram illustrating arrangement of first and second oxygen sensors according to an embodiment of the present invention.

FIG. 4 is a flowchart illustrating a method for controlling an air-fuel ratio of a CNG engine according to an embodiment of the present invention.

FIG. 5 is a graph illustrating a change in output voltages according to lambda values of the first and second oxygen sensors according to an embodiment of the present invention.

FIGS. 6A and 6B are views illustrating behavior of lambda values at opposing ends of a normal three-way catalyst and an abnormal three-way catalyst, respectively.

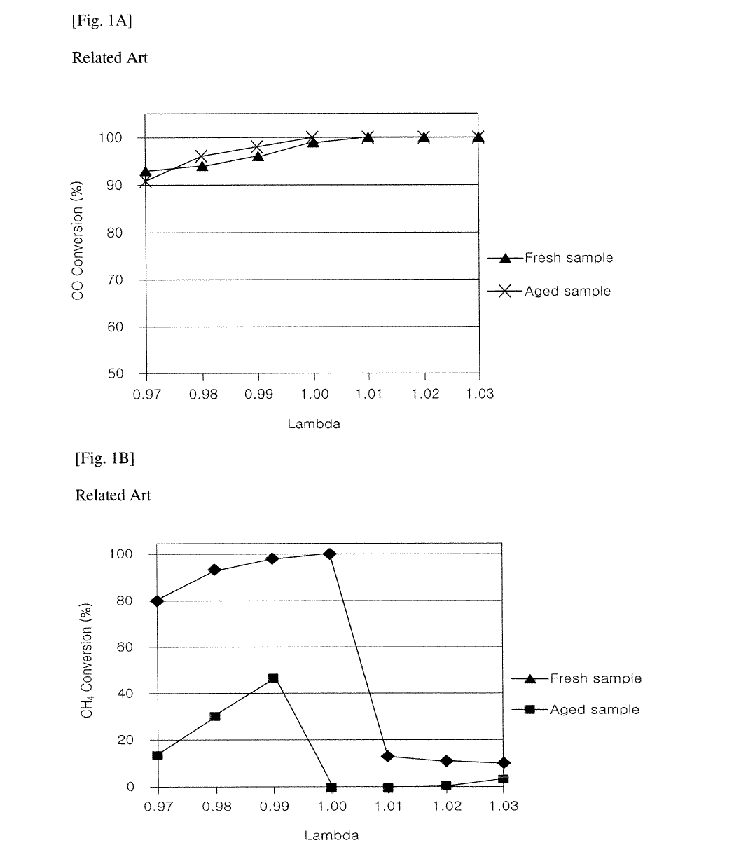

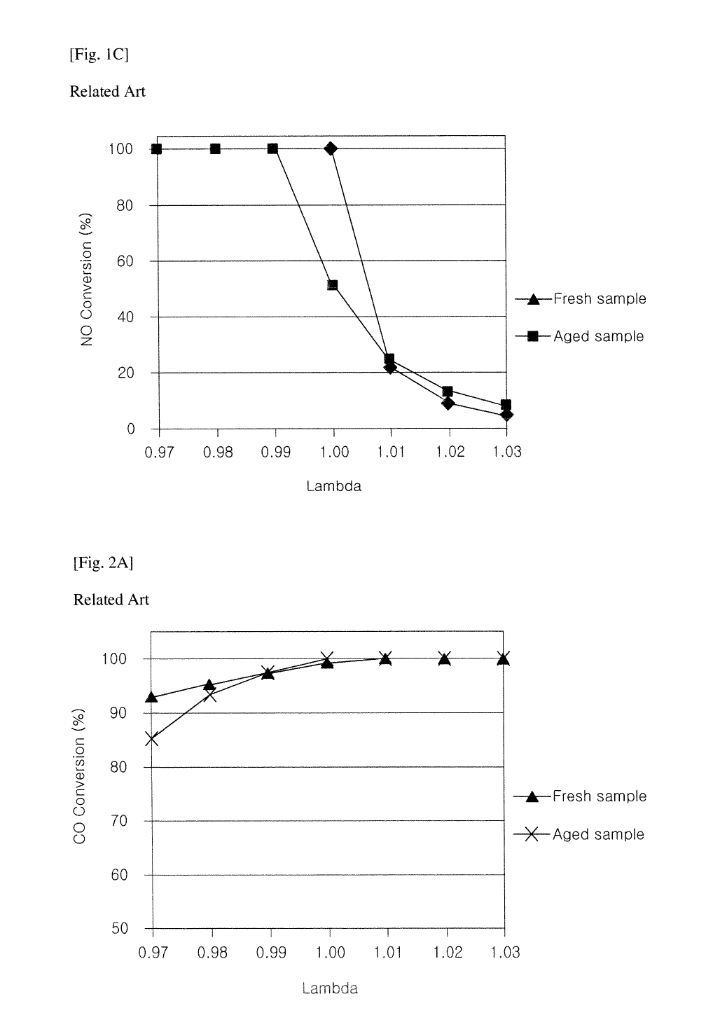

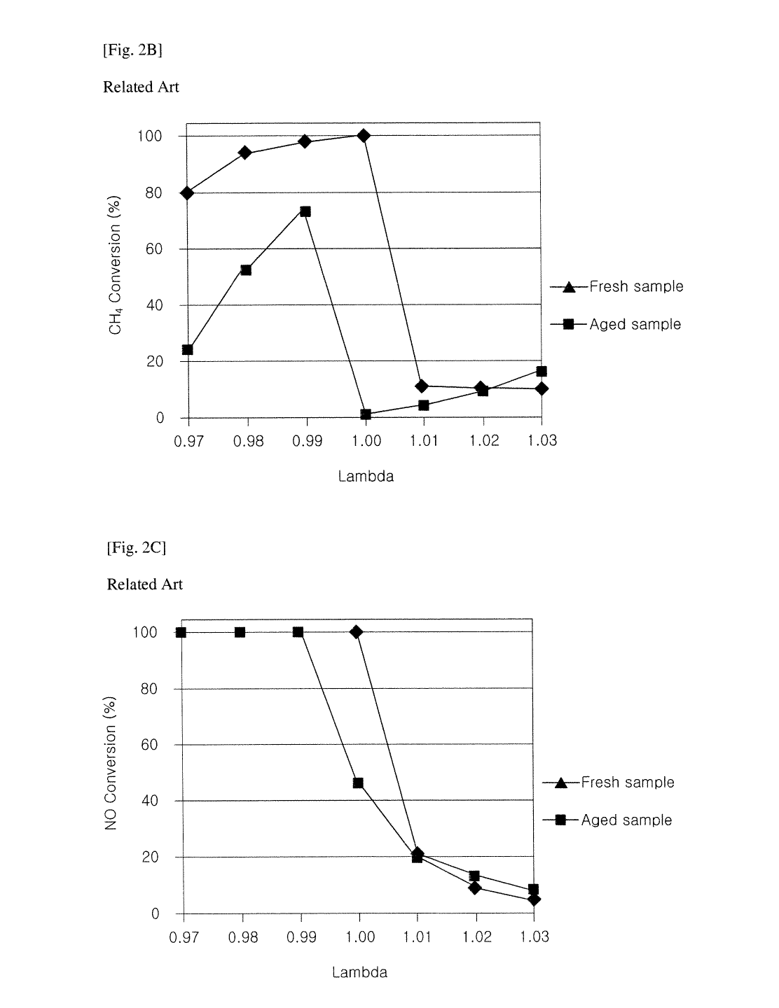

### DETAILED DESCRIPTION

Exemplary embodiments of the present invention will be described below in more detail with reference to the accompanying drawings, but the present invention is not limited or restricted to the embodiments set forth herein. For reference, in certain embodiments, detailed descriptions of constructions well known in the art may be omitted to avoid obscuring appreciation of the disclosure by a person of ordinary skill in the art or the contents apparent to a person of ordinary skill in the art may be omitted. Throughout the disclosure, like reference numerals refer to like parts throughout the various figures and embodiments of the present invention.

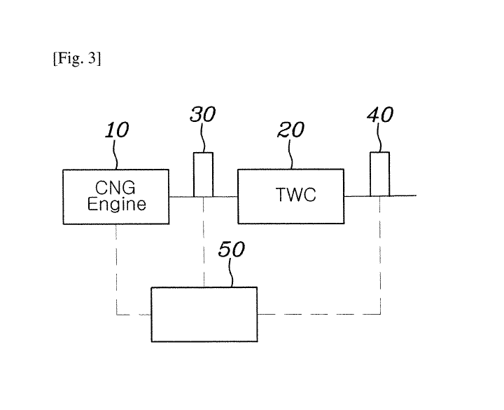

FIG. 3 is a diagram illustrating arrangement of first and second oxygen sensors according to an embodiment of the present invention.

As shown in FIG. 3, a first oxygen sensor 30 is disposed at an end of a CNG engine 10 and a second oxygen sensor 40 is disposed at an end of a three-way catalyst (TWC) 20, according to an embodiment of the present invention.

A method for controlling an air-fuel ratio of a CNG engine according to the embodiment of the present invention may determine whether or not the CNG engine 10 and the three-way catalyst 20 are abnormal by measuring output voltages of the first and second oxygen sensors 30 and 40. The determination method thereof will be described later.

In addition, exhaust gas purification efficiency may be improved by determining whether or not the three-way catalyst 20 is aged and adjusting an air-fuel ratio of the CNG engine 10 such that when aging of the three-way catalyst 20 is determined, the aged three-way catalyst has maximum activation.

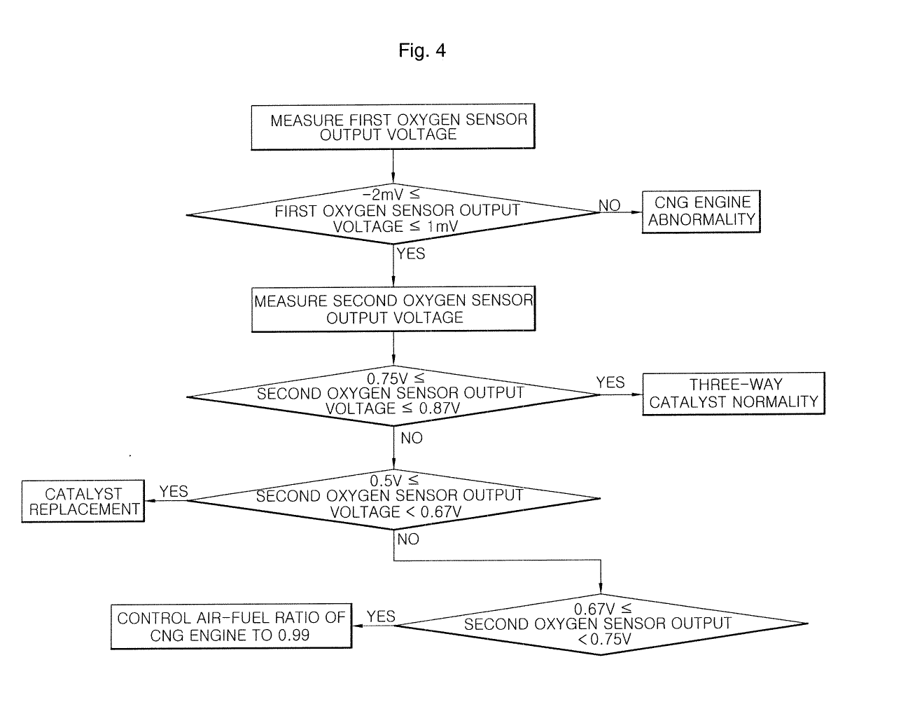

FIG. 4 is a flowchart illustrating the method for controlling an air-fuel ratio of a CNG engine according to the embodiment of the present invention.

As shown in FIG. 4, the method for controlling an air-fuel ratio of a CNG engine according to the embodiment of the present invention includes a step of measuring the output voltage of the first oxygen sensor 30, a step of determining whether or not the CNG engine 10 is normal, a step of measuring the output voltage of the second oxygen sensor 40, a step of determining whether or not the three-way catalyst 20 is normal, a step of determining whether or not the three-way catalyst 20 is aged, and a step of adjusting the air-fuel ratio of the CNG engine 10 according to the aged status of the three-way catalyst 20.

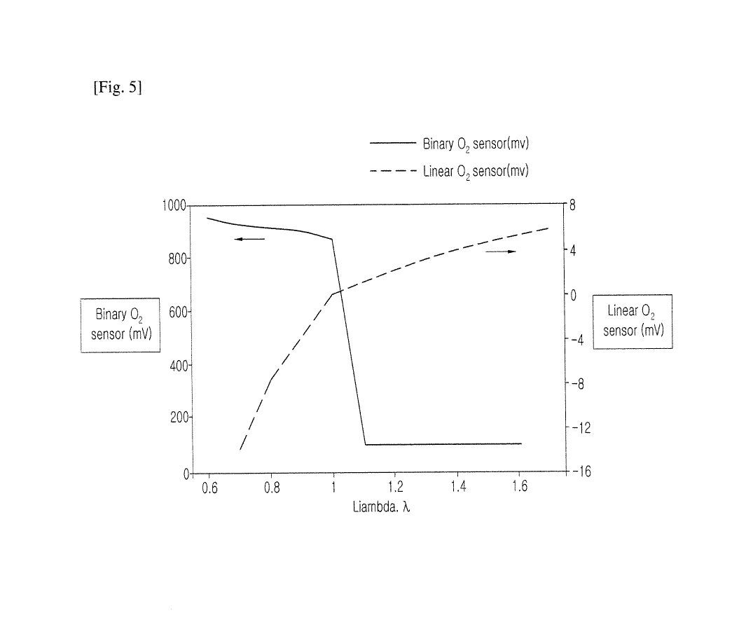

FIG. 5 is a graph illustrating a change in output voltages according to lambda values of the first and second oxygen sensors according to the embodiment of the present invention.

As shown in FIG. 5, in certain embodiments, it is preferable that the first oxygen sensor 30 is a linear oxygen sensor and the second oxygen sensor 40 is a binary oxygen sensor.

Such a configuration is because the binary oxygen sensor may easily determine whether or not the three-way catalyst 20 is aged by generally using a rapid change of the output voltage of the binary oxygen sensor on the basis of the air-fuel ratio indicative of the maximum activation of the three-way catalyst 20 used in the CNG engine 10, namely, on the basis of a case in which the lambda is 1.00.

When the output voltage of the first oxygen sensor 30 as the linear oxygen sensor is transferred to a controller 50, the step of determining whether or not the CNG engine 10 is normal is performed by comparing a first CNG reference range preset by the controller 50 with the output voltage of the first oxygen sensor 30.

In certain embodiments, the first CNG reference range is −2 mV to 1 mV. When the output voltage of the first oxygen sensor 30 is less than or equal to the lowest value in the range, or more than or equal to the highest value in the first CNG reference range due to abnormal generation of the CNG engine 10, the CNG engine 10 is determined to be abnormal and the operation ends. Consequently, maintenance of the CNG engine 10 is performed.

When the output voltage of the first oxygen sensor 30 is measured to be within the first CNG reference range and the CNG engine 10 is determined to be normal, the output voltage of the second oxygen sensor 40 is measured.

In the step of determining whether or not the three-way catalyst 20 is normal when the output voltage of the second oxygen sensor 40 is input to the controller 50, the controller 50 determines whether or not the three-way catalyst 20 is normal by comparing a preset first TWC reference range with the output voltage of the second oxygen sensor 40.

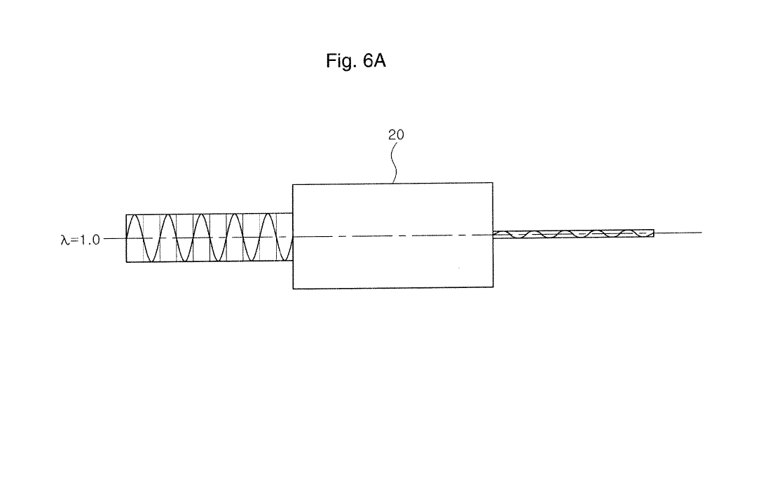

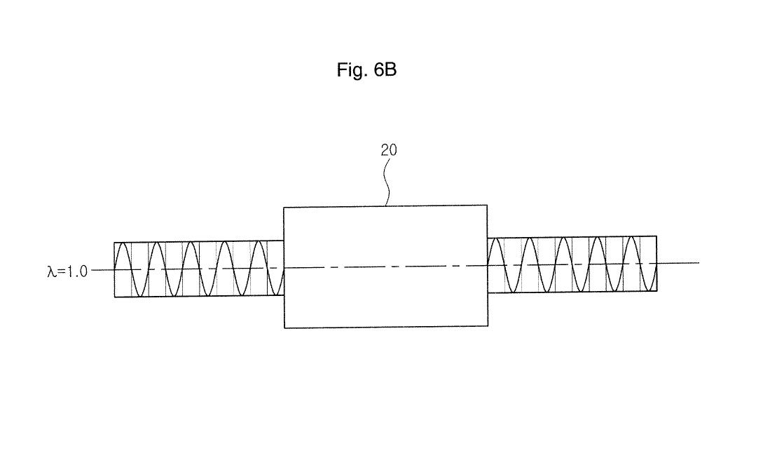

FIG. 6A is a view illustrating behavior of lambda values at opposing ends of a normal three-way catalyst. FIG. 6B is a view illustrating behavior of lambda values at opposing ends of an abnormal three-way catalyst.

As shown in FIGS. 6A, in a normal three-way catalyst 20, the lambda value at the front end of the three-way catalyst 20 indicates a constant amplitude, and the amplitude is decreased after passing through the three-way catalyst 20. However, as shown in FIG. 6B, when the purification function is lost due to abnormal generation of the three-way catalyst 20, the lambda values at both opposing ends of the three-way catalyst 20 indicate the same behavior.

That is, the controller 50 determines that the three-way catalyst 20 loses a function as a catalyst when the output voltage of the second oxygen sensor 40 exceeds a first TWC reference range.

In certain embodiments, the first TWC reference range is 0.75 V to 0.87 V. When the output voltage of the second oxygen sensor 40 as the binary oxygen sensor is in the first TWC reference range, the three-way catalyst 20 is determined to normally purify exhaust gas and the air-fuel ratio of the CNG engine 10 is maintained such that the CNG engine 10 is operated in a state in which the lambda value is 1.00.

However, when the output voltage of the second oxygen sensor 40 is out of the first TWC reference range, which in certain embodiments, is when it is more than 0.87 V or less than 0.75 V, the three-way catalyst 20 is determined as being in an abnormal state in which the exhaust gas of the CNG engine 10 operated in a state in which the lambda value is 1.00 is not normally purified.

When it is determined that the three-way catalyst 20 is in the abnormal state, the controller 50 determines whether or not the three-way catalyst 20 is aged by comparing a preset second TWC reference range with the output voltage of the second oxygen sensor 40, in the step of determining whether or not the three-way catalyst 20 is aged.

In certain embodiments, the second TWC reference range set by the controller 50 is 0.67 V to 0.75 V. When the output voltage of the second oxygen sensor 40 is in the second TWC reference range, the controller 50 determines that the three-way catalyst 20 is aged. In addition, when the output voltage of the second oxygen sensor 40 is in a third TWC range of 0.5 V to 0.67 V, it is determined that the three-way catalyst 20 is faulty or the life thereof is expired, thereby performing replacement of the three-way catalyst 20.

When the three-way catalyst 20 is determined to be aged, the controller 50 transmits an operation signal to the CNG engine 10 to adjust the air-fuel ratio, such that the lambda value of the CNG engine 10 is 0.99.

In the related art, it is determined that the three-way catalyst 20 loses a function as a catalyst when the three-way catalyst 20 is aged, and thus the three-way catalyst 20 is simply replaced. However, the method for controlling an air-fuel ratio of a CNG engine according to embodiments of the present invention may increase the life of the three-way catalyst 20 and improve purification efficiency for the exhaust gas by allowing the aged three-way catalyst 20 to have maximum activation.

In accordance with the exemplary embodiments of the present invention, it may be possible to easily determine whether or not a CNG engine and a three-way catalyst are abnormal through output voltages of first and second oxygen sensors.

In addition, it may be possible to improve a life and purification efficiency of the three-way catalyst by adjusting an air-fuel ratio of the CNG engine such that the three-way catalyst has maximum activation when purification efficiency for exhaust gas is deteriorated due to aging of the three-way catalyst.

In addition, it may be possible to easily determine a replacement time of the three-way catalyst.

While the present invention has been described with respect to the specific embodiments, it will be apparent to those skilled in the art that various changes and modifications may be made without departing from the spirit and scope of the invention as defined in the following claims.

What is claimed is:

1. A method for controlling an air-fuel ratio of a CNG engine, in which a first oxygen sensor is connected to the CNG engine and a second oxygen sensor is connected to a three-way catalyst, the method comprising:
determining whether or not the CNG engine and the three-way catalyst are normal by measuring output voltages of the first and second oxygen sensors;
determining whether or not the three-way catalyst is aged; and
adjusting the air-fuel ratio of the CNG engine based on a result of the step of determining whether or not the three-way catalyst is aged.

2. A method for controlling an air-fuel ratio of a CNG engine, in which a first oxygen sensor is connected to the CNG engine and a second oxygen sensor is connected to a three-way catalyst, the method comprising:
measuring an output voltage of the first oxygen sensor;
determining whether or not the CNG engine is normal by comparing the output voltage of the first oxygen sensor with a first CNG reference range;
measuring an output voltage of the second oxygen sensor;
determining whether or not the three-way catalyst is normal by comparing the output voltage of the second oxygen sensor with a first TWC reference range;
determining whether or not the three-way catalyst is aged by comparing the output voltage of the second oxygen sensor with a second TWC reference range; and
adjusting the air-fuel ratio of the CNG engine according to a result of the step of determining whether or not the three-way catalyst is aged.

3. The method of claim 2, wherein the first oxygen sensor is a linear oxygen sensor and the second oxygen sensor is a binary oxygen sensor.

4. The method of claim 3, wherein, in the step of determining whether or not the CNG engine is normal, the first CNG reference range is −2 mV to 1 mV, and the CNG engine is determined to be abnormal when the output voltage of the first oxygen sensor is less than −2 mV or greater than 1 mV.

5. The method of claim 3, wherein, in the determining whether or not the three-way catalyst is normal, the first TWC reference range is 0.75 V to 0.87 V, and the three-way catalyst is determined to be normal when the output voltage of the second oxygen sensor is in the first TWC reference range.

6. The method of claim 3, wherein, in the step of determining whether or not the three-way catalyst is aged, the second TWC reference range is 0.67 V to 0.75 V, and the three-way catalyst is determined to be aged when the output voltage of the second oxygen sensor is in the second TWC reference range.

7. The method of claim 6, wherein, in the step of adjusting the air-fuel ratio, the air-fuel ratio of the CNG engine is adjusted to be 0.99 when the three-way catalyst is determined to be aged.

8. The method of claim 2, further comprising:
replacing the three-way catalyst when the output voltage of the second oxygen sensor is below the second TWC reference range.

9. The method of claim 6, further comprising:
replacing the three-way catalyst when the output voltage of the second oxygen sensor is less than 0.67 V.

10. A system comprising:
a CNG engine;
a three-way catalyst;
a first oxygen sensor connected to the CNG engine;
a second oxygen sensor connected to the three-way catalyst; and
a controller configured to measure an output voltage of the first oxygen sensor,
determine whether or not the CNG engine is normal by comparing the output voltage of the first oxygen sensor with a first CNG reference range,
measure an output voltage of the second oxygen sensor,
determine whether or not the three-way catalyst is normal by comparing the output voltage of the second oxygen sensor with a first TWC reference range, determine whether or not the three-way catalyst is aged by comparing the output voltage of the second oxygen sensor with a second TWC reference range, and
adjust an air-fuel ratio of the CNG engine depending on whether or not the three-way catalyst is aged.
